(19) United States
(12) Patent Application Publication
(10) Pub. No.: US 2015/0042794 A1
(43) Pub. Date: Feb. 12, 2015

(54) SYSTEM AND METHOD FOR ADJUSTING INTERNET PROTOCOL CAMERA

(71) Applicant: HON HAI PRECISION INDUSTRY CO., LTD., New Taipei (TW)

(72) Inventors: JUI-LUNG LIN, New Taipei (TW); ZHEN-HONG WU, New Taipei (TW); YI-WEN CAI, New Taipei (TW)

(73) Assignee: HON HAI PRECISION INDUSTRY CO., LTD., New Taipei (TW)

(21) Appl. No.: 14/221,293

(22) Filed: Mar. 21, 2014

(30) Foreign Application Priority Data
Aug. 7, 2013 (TW) 102128264

(51) Int. Cl. H04N 5/225; H04N 7/18

(52) U.S. Cl. CPC H04N 5/2251; H04N 7/181
USPC 348/143

(57) ABSTRACT

A method for adjusting an Internet Protocol (IP) camera reads a gravity acceleration value monitored by a monitoring unit in the IP camera. The method determines whether a gravity acceleration value exceeds a preset threshold value when the gravity acceleration value is different from a preset acceleration value. The method further determines whether the IP camera is abnormal when the gravity acceleration value exceeds the preset threshold value. If the IP camera is abnormal, an alarm unit of the IP camera outputs alarm signals according to a preset alarm mode.

### FIELD

Embodiments of the present disclosure relate to device adjustment technology, and particularly to a system and method for adjusting an internet protocol (IP) camera.

### BACKGROUND

An Internet protocol (IP) camera is a combination of a traditional camera and network technology. Images are manually monitored of IP camera through a local area network or the Internet. However, if the IP camera is moved or shifted because of an external force, movement or shift of the IP camera cannot be detected in a timely manner. Therefore, the moved or shifted IP camera may not be able to be adjusted in time, and images captured by the moved or shifted IP camera may be useless.

### BRIEF DESCRIPTION OF THE DRAWINGS

Implementations of the present disclosure will now should be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views

FIG. 1 is a block diagram of one embodiment of an IP camera including an adjustment system.

FIG. 2 is a block diagram of one embodiment of function modules of an adjustment system of a IP camera.

FIG. 3 is a flowchart of a first embodiment of a method for adjusting the IP camera of FIG. 1.

FIG. 4 is a flowchart diagram of a second embodiment of continuously adjusting the IP camera of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.”

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an EPROM. The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

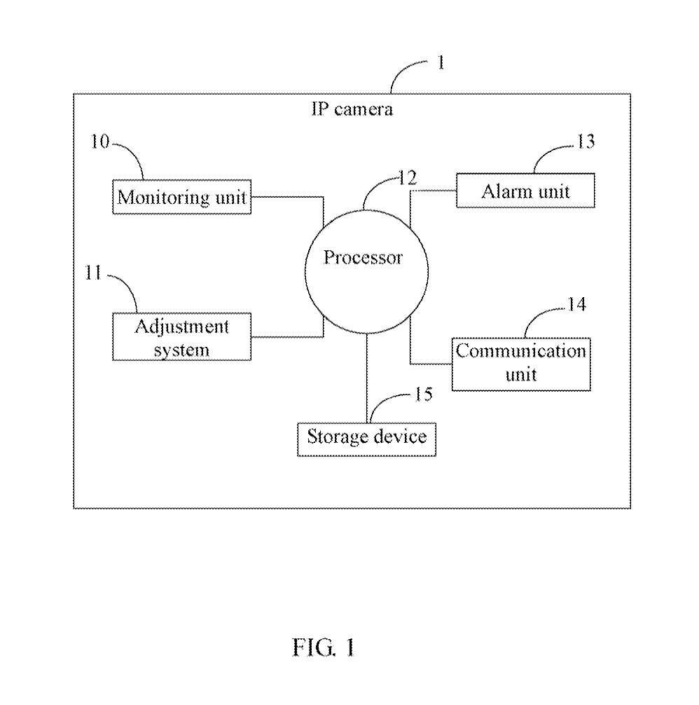

FIG. 1 is a block diagram of one embodiment of an internet protocol (IP) camera 1 including an adjustment system 11. The IP camera 1 further includes a monitoring unit 10, an alarm unit 13 and a communication unit 14. In one embodiment, the monitor unit 10 may detect a gravity acceleration value based on a preset coordinate system of the IP camera 1. For example, the monitor unit 10 may be a gravity sensor (G-sensor). In other embodiments, the monitor unit 10 may further include an orientation sensor (e.g. an electronic compass) for detecting orientation parameters of the IP camera 1. In some embodiments, the orientation parameters include an azimuth angle and a pitching angle of the IP camera 1.

The IP camera 1 controls the alarm unit 13 to output alarm signals. The alarm unit 13 may be internal to the IP camera 1, or may be externally connected to the IP camera 1. In one embodiment, the alarm unit 13 may be a display screen displaying visible alarm information, a loudspeaker for outputting audio alarm signals, and an indicator light (not shown in FIG. 1) that lights. The IP camera 1 communicates with electronic devices (e.g. a mobile phone, or a computer device) using the communication unit 14 and a network (not shown in FIG. 1). For example, the IP camera 1 may send messages (e.g., Short Message Service (SMS) messages) or e-mails to the electronic devices using the communication unit 14 and the network.

The IP camera 10 further includes at least one processor 12 and a storage device 15. The at least one processor 12 executes one or more computerized codes and other applications of the IP camera 1, to provide functions of the adjustment system 11. The storage device 15 may be a dedicated memory, such as an erasable programmable read-only memory (EPROM), a hard disk drive (HDD), or flash memory.

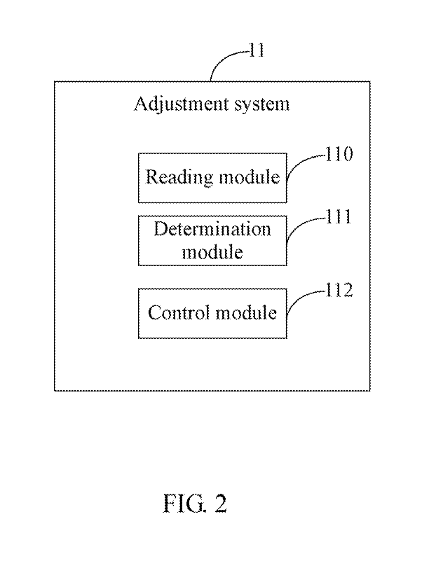

FIG. 2 is a block diagram illustrating function modules of the adjustment system 11. In this embodiment, the adjustment system 11 includes a reading module 110, a determination module 111, and a control module 112. The modules 110-112 include computerized code in the form of one or more programs that are stored in the non-transitory storage device 15 of the IP camera 10. The computerized code includes instructions that are executed by at least one processor 12 of the IP camera 10 to provide functions of the adjustment system 11. A description of each module of the adjustment system 11 is given in the following paragraphs.

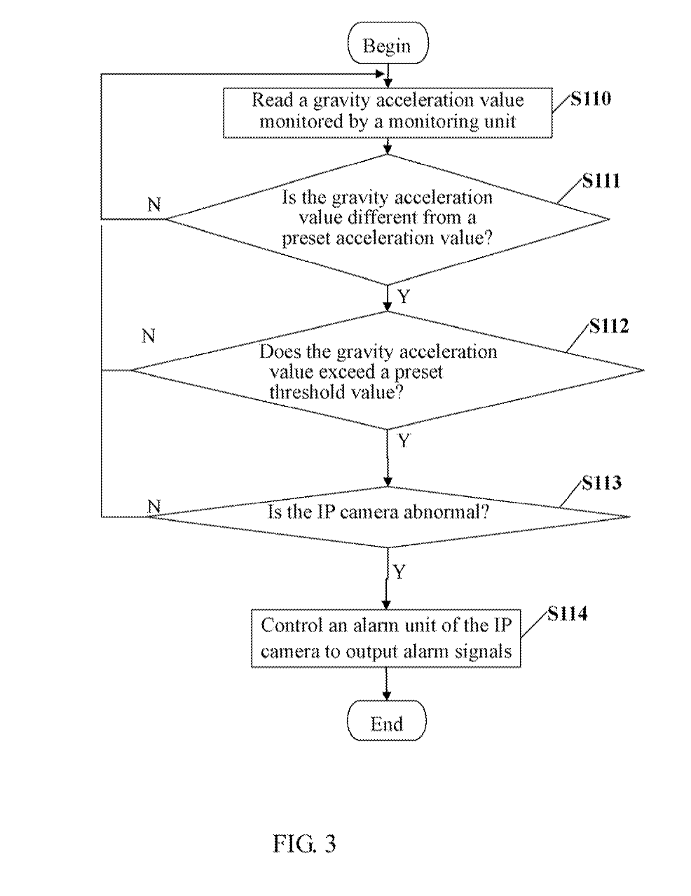

FIG. 3 is a flowchart of a first embodiment of a method for adjusting the IP camera 1. Depending on the embodiment, additional steps may be added, others removed, and the ordering of the steps may be changed.

In step S110, the reading module 110 reads a gravity acceleration value of the IP camera 1 from the monitoring unit 10 at a predetermined time intervals (e.g. 5 seconds).

In step S111, the determination module 111 determines whether the read gravity acceleration value is different from a preset acceleration value. In one embodiment, the preset acceleration value is a standard gravity acceleration value when the IP camera 1 is in a rest state. For example, the preset acceleration value may be set as 9.80665 (m/s²). If the read gravity acceleration value is different from the preset acceleration value, that is, the IP camera 1 is moving, then step S112 is implemented. If the read gravity acceleration value is the same as the preset acceleration value, step S110 is repeated.

In step S112, the determination module 111 determines whether the read gravity acceleration value exceeds a preset threshold value. If the read gravity acceleration value exceeds the preset threshold value, step S113 is implemented. If the read gravity acceleration value does not exceed the preset threshold value, the procedure returns to step S110.

In step S113, the determination module 111 determines whether the IP camera 1 is abnormal according to gravity acceleration values of the IP camera 1. If the IP camera 1 is abnormal, step S114 is implemented. If the IP camera 1 is normal, the procedure returns to step S110.

In one embodiment, the determination module 111 rereads a current gravity acceleration value of the IP camera 1 from the monitor unit 10, and determines whether the current gravity acceleration value exceeds the preset threshold value when the current gravity acceleration value is different from the preset acceleration value. When the current gravity acceleration value exceeds the preset threshold value, the determination module 111 determines whether a difference value between the current gravity acceleration value and a previous gravity acceleration value (e.g. the read gravity acceleration value as mentioned in step S110) exceeds a preset difference value. If the difference value exceeds the preset difference value, the IP camera 1 is determined to be abnormal. If the current gravity acceleration value is the same as the preset acceleration value, or the current gravity acceleration value does not exceed the preset threshold value, or the difference value does not exceed the preset difference value, the IP camera 1 is determined to be normal.

In step S114, the control module 112 controls the alarm unit 13 to output alarm signals according to a preset alarm mode, for notifying a user to adjust the IP camera 1. In one embodiment, the control module 112 may further control the communication module 14 to output a preset alarm notification to preset electronic devices which are in connection with the IP camera 1. For example, the preset alarm notification may be a predetermined message or an e-mail including contents of “IP camera 1 is shifted, please adjust the IP camera 1”.

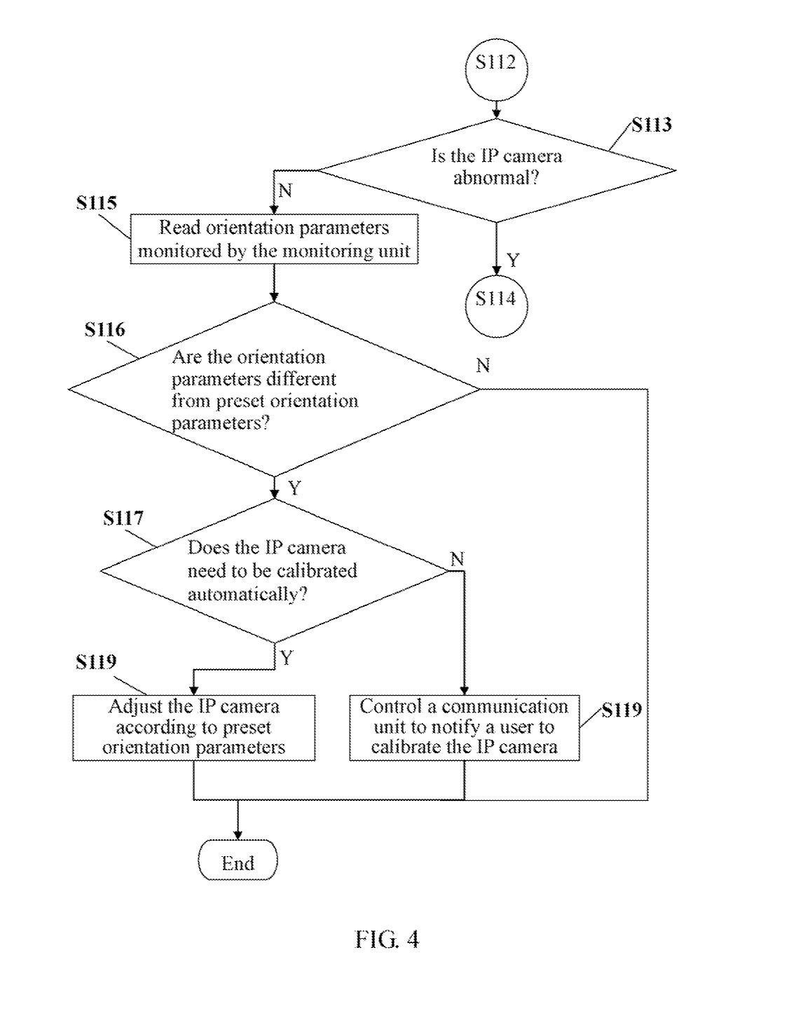

FIG. 4 is a flowchart diagram of a second embodiment of continuously adjusting the IP camera 1 when the monitoring unit 10 includes the orientation sensor for detecting orientation parameters of the IP camera 1. Depending on the embodiment, additional steps may be added, others removed, and the ordering of the steps may be changed. In a first embodiment, if the IP camera 1 is determined to be normal, step S115 as provided below is implemented. In a second embodiment, the step S115 may be executed with the step S110 synchronously.

In step S115, the reading module 110 reads orientation parameters monitored by the monitoring unit 10.

In step S116, the determination module 111 determines whether the orientation parameters are different from preset orientation parameters. If the orientation parameters are different from the preset orientation parameters, step S117 is implemented. If the orientation parameters are the same as the preset orientation parameters, the procedure ends.

In step S117, the determination module 111 determines whether a difference between the orientation parameters and the preset orientation parameters is within a preset adjustment range. If the difference between the orientation parameters and the preset orientation parameters is within the preset adjustment range, that is, the IP camera 1 can be adjusted automatically, step S119 is implemented. If the difference is beyond the preset adjustment range, that is, the IP camera 1 does not need to be adjusted automatically, and step S118 is implemented.

In step S118, the control module 112 controls the communication unit 14 to output the preset adjustment notification to the preset electronic devices, and the procedure ends.

In step S119, the control module 112 adjusts the IP camera 1 according to the preset orientation parameters. In one embodiment, the control module 112 may control the IP camera 1 to rotate on a turntable (not shown in FIGS.) of the IP camera 1, until the orientation parameters of the IP camera 1 are the same as the preset orientation parameters.

In other embodiments, when the IP camera 1 is rotated, if a variation value of azimuth angels monitored by the monitoring unit 10 is different from a preset angel variation value, the determination module 111 determines that the IP camera 1 cannot be adjust normally and the control module 112 controls the communication unit 14 to output the preset adjustment notification. If a duration of a rotation process of the IP camera 1 exceeds a preset time period, the determination module 111 determines that the IP camera 1 needs to be repaired and the control module 112 controls the communication unit 14 to output a preset repair notification to the preset electronic devices.

All of the processes described above may be embodied in, and fully automated via, functional code modules executed by one or more general purpose processors such as the processor 12. The code modules may be stored in any type of non-transitory readable medium or other storage device such as the storage device 15. Some or all of the methods may alternatively be embodied in specialized hardware. Depending on the embodiment, the non-transitory readable medium may be a hard disk drive, a compact disc, a digital versatile disc, a tape drive, or other suitable storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A method for adjusting an Internet Protocol (IP) camera, the method comprising:
reading a gravity acceleration value of the IP camera from a monitoring unit of the IP camera at a predetermined time interval;
determining whether the gravity acceleration value exceeds a preset threshold value when the gravity acceleration value is different from a preset acceleration value;
determining whether the IP camera is abnormal according to gravity acceleration values of the IP camera when the gravity acceleration value exceeds the preset threshold value; and
controlling an alarm unit of the IP camera to output alarm signals according to a preset alarm mode, when the IP camera is abnormal.

2. The method according to claim 1, wherein the IP camera is determined to be abnormal by:
reading a current gravity acceleration value from the monitor unit;
determining whether the current gravity acceleration value exceeds the preset threshold value when the current gravity acceleration value is different from the preset acceleration value;
determining whether a difference value between the current gravity acceleration value and a previous gravity acceleration value exceeds a preset difference value; and
determining that the IP camera is abnormal when the difference value between the current gravity acceleration value and the previous gravity acceleration value exceeds the preset difference value; or
determining that the IP camera is normal, when the current gravity acceleration value is the same as the preset acceleration value, or the current gravity acceleration value does not exceeds the preset threshold value, or the difference value does not exceed the preset difference value.

3. The method according to claim 1, further comprising:
reading orientation parameters monitored by the monitoring unit;
determining whether a difference between the orientation parameters and preset orientation parameters is within a preset adjustment range, when the orientation parameters are different from the preset orientation parameters; and
controlling the IP camera to output a preset adjustment notification when the difference between the orientation parameters and preset orientation parameters is not within the preset adjustment range; or
adjusting the IP camera according to the preset orientation parameters when the difference between the orientation parameters and preset orientation parameters is within the preset adjustment range.

4. The method according to claim 3, wherein the IP camera is determined to be adjusted automatically when the difference between the orientation parameters and the preset orientation parameters is within the preset adjustment range, and the IP camera is determined not to be adjusted automatically when the difference between the orientation parameters and the preset orientation parameters is beyond the preset adjustment range.

5. The method according to claim 1, further comprising:
controlling the IP camera to output a preset alarm notification to predetermined electronic devices which are in connection with the IP camera.

6. The method according to claim 1, wherein the alarm unit comprises a display screen, a loudspeaker, and an alarm indicator light.

7. A Internet Protocol (IP) camera, the IP camera comprising:
at least one processor; and
a storage device storing one or more programs, when executed by the at least one processor, cause the at least one processor to perform operations of:
reading a gravity acceleration value of the IP camera from a monitoring unit of the IP camera at a predetermined time interval;
determining whether the gravity acceleration value exceeds a preset threshold value when the gravity acceleration value is different from a preset acceleration value;
determining whether the IP camera is abnormal according to gravity acceleration values of the IP camera when the gravity acceleration value exceeds the preset threshold value;
controlling an alarm unit of the IP camera to output alarm signals according to a preset alarm mode, when the IP camera is abnormal.

8. The IP camera according to claim 7, wherein the IP camera is determined to be abnormal by:
reading a current gravity acceleration value from the monitor unit;
determining whether the current gravity acceleration value exceeds the preset threshold value when the current gravity acceleration value is different from the preset acceleration value;
determining whether a difference value between the current gravity acceleration value and a previous gravity acceleration value exceeds a preset difference value;
determining that the IP camera is abnormal when the difference value between the current gravity acceleration value and the previous gravity acceleration value exceeds the preset difference value;
determining that the IP camera is normal, when the current gravity acceleration value is the same as the preset acceleration value, or the current gravity acceleration value does not exceeds the preset threshold value, or the difference value does not exceed the preset difference value.

9. The IP camera according to claim 7, further comprising:
reading orientation parameters monitored by the monitoring unit;
determining whether a difference between the orientation parameters and preset orientation parameters is within a preset adjustment range, when the orientation parameters are different from the preset orientation parameters; and
controlling the IP camera to output a preset adjustment notification when the difference between the orientation parameters and preset orientation parameters is not within the preset adjustment range; or
adjusting the IP camera according to the preset orientation parameters when the difference between the orientation parameters and preset orientation parameters is within the preset adjustment range.

10. The IP camera according to claim 9, wherein the IP camera is determined to be adjusted automatically when the difference between the orientation parameters and the preset orientation parameters is within the preset adjustment range, and the IP camera is determined not to be adjusted automatically when the difference between the orientation parameters and the preset orientation parameters is beyond the preset adjustment range.

11. The IP camera according to claim 7, further comprising:
controlling the IP camera to output a preset alarm notification to predetermined electronic devices which are in connection with the IP camera.

12. The IP camera according to claim 7, wherein the alarm unit comprises a display screen, a loudspeaker, and an alarm indicator light.

13. A non-transitory storage medium having stored thereon instructions that, when executed by at least one processor of an Internet Protocol (IP) camera, cause the processor to perform a method for adjusting the IP camera, the method comprising:
reading a gravity acceleration value of the IP camera from a monitoring unit of the IP camera at a predetermined time interval;
determining whether the gravity acceleration value exceeds a preset threshold value when the gravity acceleration value is different from a preset acceleration value;
determining whether the IP camera is abnormal according to gravity acceleration values of the IP camera when the gravity acceleration value exceeds the preset threshold value;
controlling an alarm unit of the IP camera to output alarm signals according to a preset alarm mode, when the IP camera is abnormal.

14. The storage medium according to claim 13, wherein the IP camera is determined to be abnormal by:
reading a current gravity acceleration value from the monitor unit;
determining whether the current gravity acceleration value exceeds the preset threshold value when the current gravity acceleration value is different from the preset acceleration value;
determining whether a difference value between the current gravity acceleration value and a previous gravity acceleration value exceeds a preset difference value;
determining that the IP camera is abnormal when the difference value between the current gravity acceleration value and the previous gravity acceleration value exceeds the preset difference value;
determining that the IP camera is normal, when the current gravity acceleration value is the same as the preset acceleration value, or the current gravity acceleration value does not exceeds the preset threshold value, or the difference value does not exceed the preset difference value.

15. The storage medium according to claim 13, further comprising:
reading orientation parameters monitored by the monitoring unit;
determining whether a difference between the orientation parameters and preset orientation parameters is within a preset adjustment range, when the orientation parameters are different from the preset orientation parameters; and
controlling the IP camera to output a preset adjustment notification when the difference between the orientation parameters and preset orientation parameters is not within the preset adjustment range; or
adjusting the IP camera according to the preset orientation parameters when the difference between the orientation parameters and preset orientation parameters is within the preset adjustment range.

16. The storage medium according to claim 15, wherein the IP camera is determined to be adjusted automatically when the difference between the orientation parameters and the preset orientation parameters is within the preset adjustment range, and the IP camera is determined not to be adjusted automatically when the difference between the orientation parameters and the preset orientation parameters is beyond the preset adjustment range.

17. The storage medium according to claim 13, further comprising:
controlling the IP camera to output a preset alarm notification to predetermined electronic devices which are in connection with the IP camera.

18. The storage medium according to claim 13,
wherein the alarm unit comprises a display screen, a loudspeaker, and an alarm indicator light.
